(19) United States
(12) Patent Application Publication
(10) Pub. No.: US 2008/0118700 A1
(43) Pub. Date: May 22, 2008

(54) Honeycomb Metal Carrier and Method of Producing the Same

(75) Inventors: Takashi Tsuchiya, Tochigi (JP); Toshiyuki Horimukai, Tochigi (JP); Katsunori Okubo, Saitama (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/721,124

(22) PCT Filed: Nov. 24, 2005
(86) PCT No.: PCT/JP05/22033

§ 371 Date: Jun. 13, 2007

(30) Foreign Application Priority Data
Dec. 9, 2004 (JP) 2004-357418

(51) Int. Cl. B32B 3/12; B65H 81/00

(52) U.S. Cl. 428/116; 156/191

(57) ABSTRACT

A cylindrical honeycomb metal support (11) is provided. The metal support (11) includes a honeycomb support (12) having a cylindrical portion (17) formed in its center (16) by laminating a plurality of corrugated sheet materials (23) each in the form of a strip having a corrugated portion (24) and winding the corrugated sheet materials about their middle portions (25), and a cylindrical member (13) in which the honeycomb support is fitted. The wound ends (19, 21) of the wound corrugated sheet materials are fixed to the inner surface (22) of the cylindrical member.

### TECHNICAL FIELD

This invention relates to a cylindrical honeycomb metal support for holding a catalyst used to purify the exhaust gas of an internal combustion engine and a method of manufacturing the same.

### BACKGROUND ART

A method in which a cylindrical honeycomb body is formed by forming from a flat metal strip a member corrugated in one portion except its middle portion and remaining a flat sheet in another portion, superposing the corrugated portion of one such member on the flat portion of another member one after another, pressing the middle portions of the members together and winding them about their middle portions, and is covered with an outer cylindrical member, is, for example, proposed in JP-A-7-116758 as a method of manufacturing a cylindrical honeycomb support. This method of manufacturing a honeycomb support will be described in detail with reference to FIGS. 14A to 14C.

The known method of manufacturing a heat-resisting structure as shown in FIGS. 14A to 14C is started by forming a base material 101. The base material 101 has a corrugated sheet 103 on one side of a flat sheet 102.

Then, a plurality of base materials 101 are superposed on one another. An appropriate number of base materials 101 are superposed on one another by placing the corrugated sheet 103 of one base material in contact with the flat sheet 102 of another base material 101.

Then, the middle portions 104 of the base materials 101 are pressed together to form a flattened portion 105, and the base materials 101 are wound about the flattened portion 105 held between stopper members 106 to form a honeycomb body 107.

The honeycomb body 107 is covered with an outer cylindrical member 108 and stopper rings 109 are welded to the opposite ends, respectively, of the outer cylindrical member 108 so as to have a clearance t from the opposite ends, respectively, of the honeycomb body 107. One side 112 of each stopper member 106 is welded to one end 111 of the outer cylindrical member 108 to complete a heat-resisting structure 113.

The heat-resisting structure 113 shown in FIG. 14C is free from any thermal stress produced by expansion or contraction, since it is formed without using any brazing material, as described.

However, as the heat-resisting structure 113 described above has the clearances t between the opposite ends of the honeycomb body 107 and the stopper rings 109, it is, for example, likely that when the heat-resisting structure 113 is employed in a motor vehicle or a motorcycle, the vibration of the running vehicle may cause the honeycomb body 107 to vibrate in the outer cylindrical member 108 and eventually break.

Moreover, in the heat-resisting structure 113, the stopper members 106 which have to be welded at one side 112 to the end 111 of the outer cylindrical member 108 obstruct the flow of exhaust gas. Particularly, as one side 112 seals the end 111, it interferes with the exhaust gas flowing in the honeycomb body 107 and resists its flow.

Therefore, there is desired an art which makes it easy to prevent the rupture of the honeycomb portion by thermal expansion, prevent the rupture of the honeycomb support by vibration and raise the strength of the honeycomb support.

### DISCLOSURE OF THE INVENTION

According to this invention, there is provided a honeycomb metal support characterized by comprising a honeycomb support having a cylindrical portion formed in its center by laminating a plurality of corrugated sheet materials each in the form of a corrugated strip and winding the laminated corrugated sheet materials about their middle portions, and a cylindrical member allowing the honeycomb support to be fitted therein, a honeycomb portion being formed contiguously to and outwardly from the cylindrical portion, each of the corrugated sheet materials having a wound end formed contiguously to and outwardly from the honeycomb portion and fixed integrally to the inner surface of the cylindrical member.

Thus, according to the honeycomb metal support of this invention, the expansion of the honeycomb support by the heat of exhaust gas of a motor vehicle or motorcycle results in the deformation of the honeycomb portion contiguous to the cylindrical portion and its absorption of expansion of the corrugated sheet materials. Consequently, the honeycomb portion is hardly deformed, but its rupture by thermal expansion is prevented.

Moreover, the wound ends of the corrugated sheet materials fixed to the inner surface of the cylindrical member make it possible to prevent any movement of the honeycomb support and its rupture by vibration.

The cylindrical portion preferably has a notch formed at least at one end thereof. Accordingly, when the honeycomb support is heated by exhaust gas to cause the expansion of the corrugated sheet materials, the edge defining the notch is freely movable to absorb expansion and thereby prevent any deformation of the honeycomb portion by thermal expansion.

According to this invention, there is also provided a method of manufacturing a honeycomb metal support which comprises the step of forming a plurality of corrugated sheet materials each formed by adopting as a flat portion one portion of a strip on one side of its longitudinally middle portion and forming a corrugated portion on the other side of the middle portion, the step of laminating the corrugated sheet materials on one another so that the flat portion of one of them may lie on the corrugated portion of another, the step of winding the laminated corrugated sheet materials about their middle portions to form a cylindrical portion, the step of winding the corrugated sheet materials to a further extent to form a honeycomb support, and the step of fitting the honeycomb support in a cylindrical member and fixing the wound ends of the honeycomb support to the inner surface of the cylindrical member.

As the wound ends of the corrugated sheet materials are formed into a cylindrical shape, no time or effort is required to raise the strength of the honeycomb support against any temperature change or vibration.

### BRIEF DESCRIPTION OF THE DRAWINGS

FIGS. 1A and 1B are diagrams showing a honeycomb metal support embodying this invention, FIG. 1A being a top plan view thereof, while FIG. 1B is a view taken along the arrow 1B in FIG. 1A;

FIG. 2 is a sectional view taken along the line 2-2 in FIG. 1B;

FIG. 3 is an enlarged view of part 3 in FIG. 2;

FIG. 4 is a schematic view of an apparatus for forming corrugated sheet materials for the honeycomb metal support embodying this invention;

FIG. 5 is a perspective view of a corrugated sheet material formed by the apparatus shown in FIG. 4;

FIGS. 6A to 6C are diagrams showing a plurality of corrugated sheet materials laminated on one another and being wound about their own middle portions;

FIG. 7 is a perspective view of a honeycomb support formed by winding the laminated corrugated sheet materials and a cylindrical member allowing the honeycomb support to be fitted therein;

FIG. 8 is a diagram showing a honeycomb metal support according to another embodiment of this invention;

FIG. 9 is a perspective view of a corrugated sheet material used by the other embodiment;

FIG. 10 is a sectional view taken along the line 10-10 in FIG. 8;

FIG. 11 is a sectional view taken along the line 11-11 in FIG. 8;

FIG. 12 is a sectional view taken along the line 12-12 in FIG. 8;

FIG. 13 is a diagram showing notches in the positions thereby taken upon thermal expansion of the honeycomb support according to the other embodiment; and

FIGS. 14A to 14C are diagrams showing a known honeycomb structure.

### BEST MODE FOR CARRYING OUT THE INVENTION

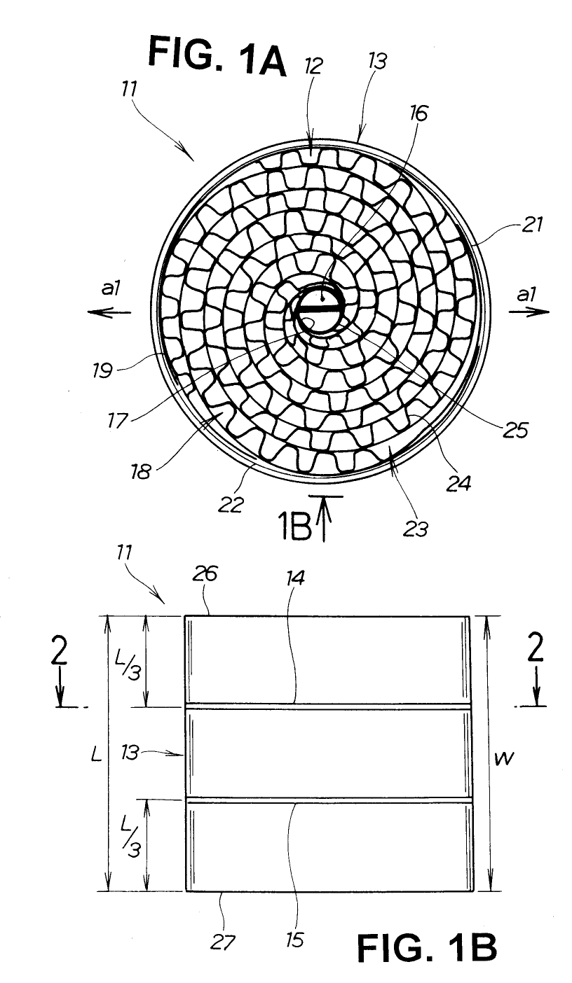

The honeycomb metal support 11 shown in FIGS. 1A and 1B comprises a honeycomb support 12, a cylindrical member 13 covering the honeycomb support 12 and welds 14 and 15 for fixing the honeycomb support 12 to the cylindrical member 13.

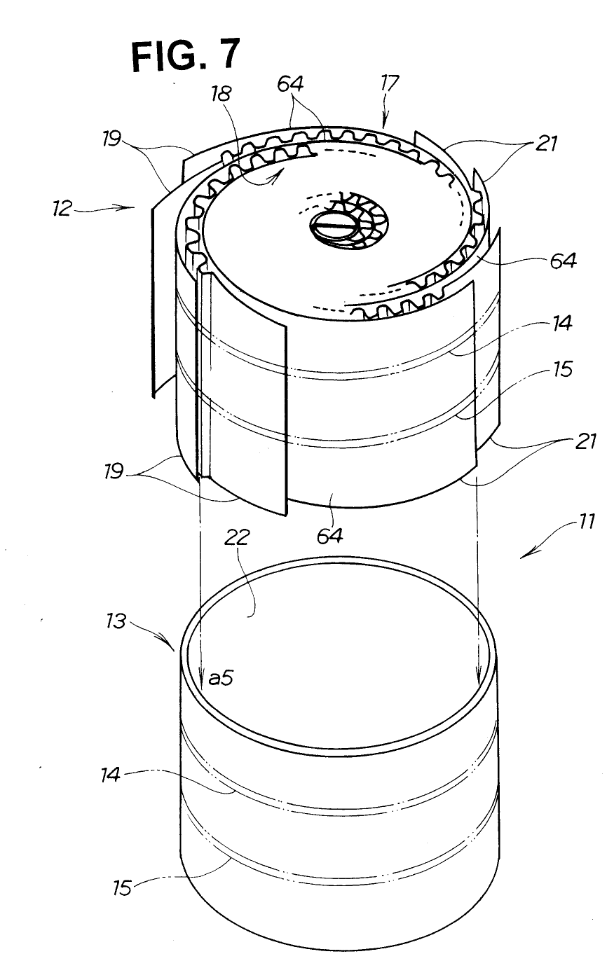

The honeycomb support 12 has a cylindrical portion 17 formed in its center 16, a honeycomb portion 18 formed contiguously to and outwardly (in the directions of arrows al) from the cylindrical portion 17 and wound ends 19 and 21 formed contiguously to and outwardly from the honeycomb portion 18 (see FIG. 7, too), the wound ends 19 and 21 being fixed to the inner surface 22 of the cylindrical member 13 integrally at the welds 14 and 15 (see FIG. 7, too).

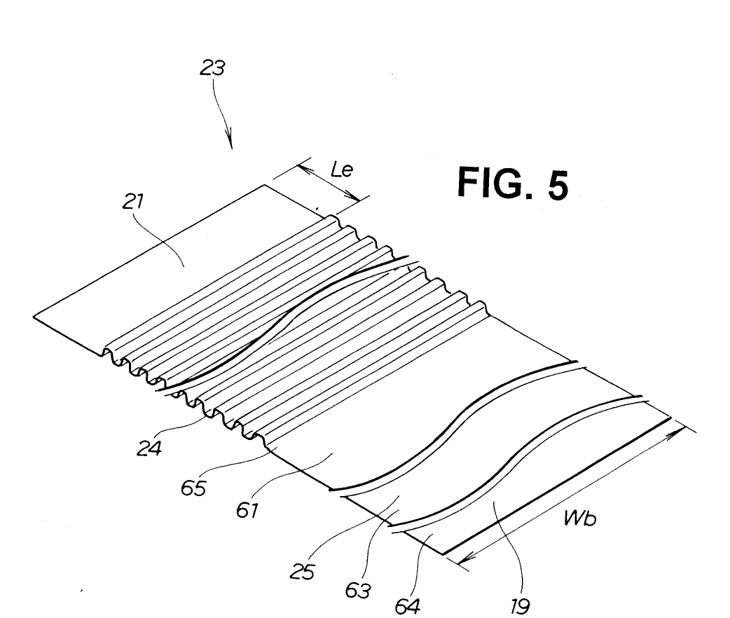

Reference numeral 23 denotes a corrugated sheet material, 24 denotes the corrugated portion of the corrugated sheet material 23 (see FIG. 5), 25 denotes the middle portion of the corrugated sheet material 23 and W denotes the width of the honeycomb metal support 11.

The cylindrical member 13 is a metal cylinder. The cylindrical member 13 has its length set at L (L=W).

The weld 14 is formed at a distance approximately equal to L/3 from one end 26 of the cylindrical member 13. Any welding method is acceptable.

The weld 15 is formed at a distance approximately equal to L/3 from the other end 27 of the cylindrical member 13. Any welding method is acceptable.

The position of the weld 15 is not limited to the distance L/3. For example, it is alternatively possible to form the weld 15 as a single one in the middle (at a distance equal to L/2), or at a distance equal to L/4 or L/5. Moreover, it is not necessary to keep an equal distance between the welds 14 and 15.

The cylindrical member 13 may alternatively be divided along its length L. For example, it can be formed by welding together three cylindrical members each having a length equal to L/3.

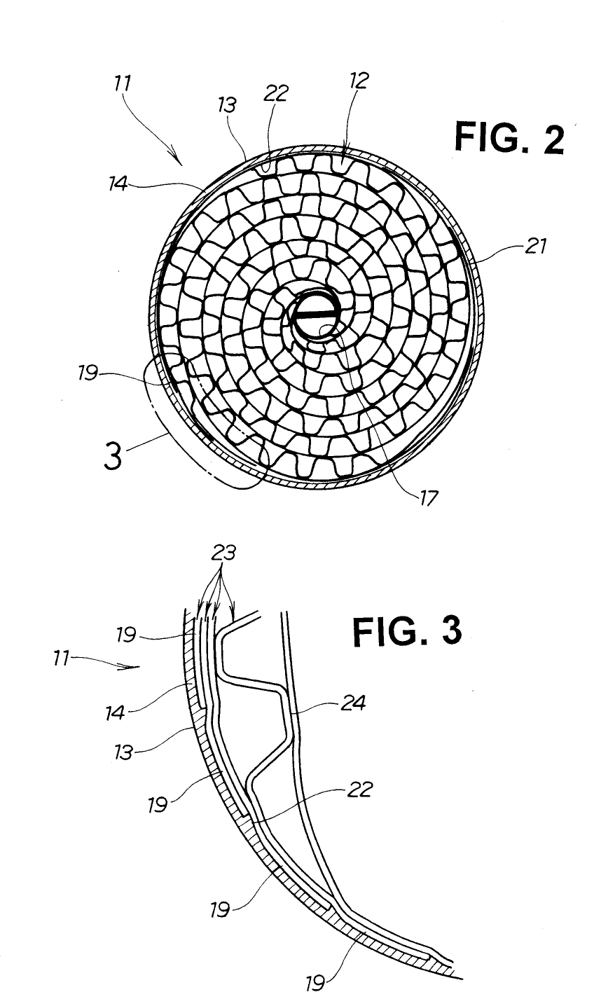

The weld 14 is a joint welding the inner surface 22 of the cylindrical member 13 and the wound ends 19 and 21 of the honeycomb support 12 along the entire circumference thereof, as shown in FIG. 2. The honeycomb support 12 is fixed along its entire circumference to the cylindrical member 13.

The weld 14 fixes the wound ends 19 of four corrugated sheet materials 23 to the inner surface 22 of the cylindrical member 13, as shown in FIG. 3, and the wound ends 21 formed opposite the wound ends 19 (see FIG. 2) are also fixed to the inner surface 22 of the cylindrical member 13 like the wound ends 19.

The weld 15 shown in FIG. 1B is similar to the weld 14 and no description thereof is, therefore, made.

While the embodiment under description has been described as employing the two welds 14 and 15 for fixing the honeycomb support 12 to the cylindrical member 13, it is also possible to fix it at three points.

While the cylindrical portion 17 is not limited in the number of turns, at least 1.5 turns is necessary to form a cylinder.

As the honeycomb support 12 in the honeycomb metal support 11 according to this invention has the cylindrical portion 17 formed in its center 16 by winding the corrugated sheet materials 23, the honeycomb portion 18 formed contiguously to and outwardly from the cylindrical portion 17 and the wound ends 19 and 21 formed contiguously to and outwardly from the honeycomb portion 18 and fixed integrally to the inner surface 22 of the cylindrical member 13, the expansion of the honeycomb support 12 by the heat of exhaust gas from a motor vehicle or motorcycle, or the expansion of the corrugated sheet materials 23 under heat causes the rotation of the cylindrical portion 17 in its center 16 in the direction of winding and thereby the deformation of the honeycomb portion 18 contiguous to the cylindrical portion 17 to absorb the expansion of the corrugated sheet materials 23. Consequently, the honeycomb portion 18 is hardly deformed, but its rupture by thermal expansion can be avoided. Moreover, the opposite wound ends of the corrugated sheet materials 23 are fixed to the cylindrical member 13. Therefore, it is possible to prevent any movement of the honeycomb support 12 and its rupture by vibration.

Moreover, the cylindrical portion 17 formed in the center 16 of the honeycomb support 12 holds the corrugated sheet materials 23 in its center 16 in intimate contact with one another and prevents their separation from one another. It is, therefore, possible to raise the strength of the honeycomb support 12 in its center 16.

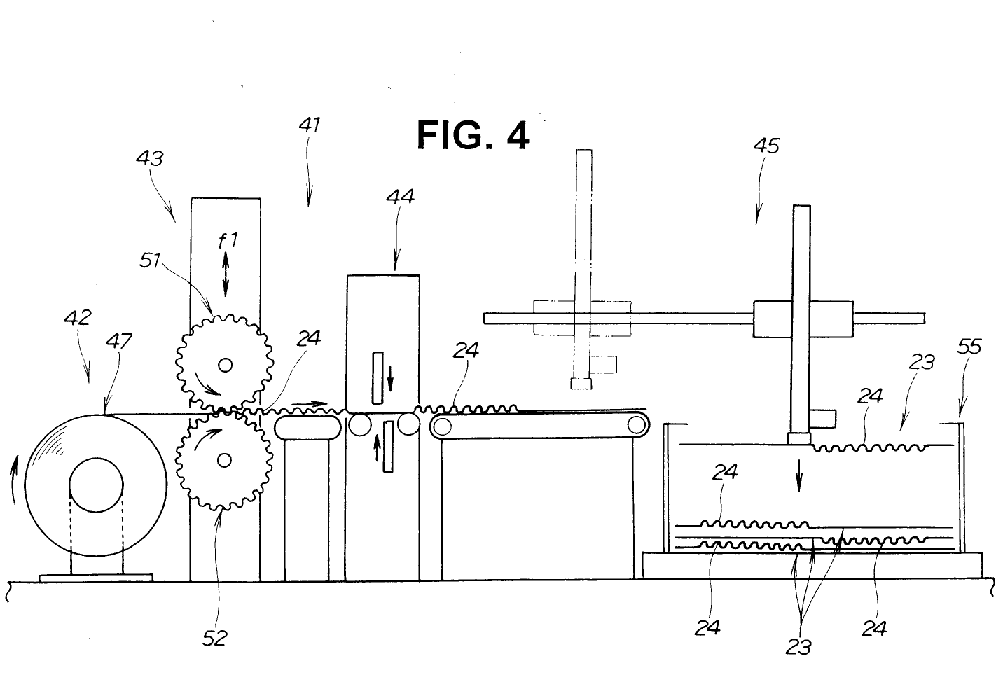

An apparatus and a method for manufacturing the honeycomb metal support 11 embodying this invention will now be described with reference to FIGS. 4 to 7.

FIG. 4 shows a forming apparatus used by a method of manufacturing the honeycomb metal support embodying this invention.

Referring to FIG. 4, the forming apparatus 41 is used to form corrugated sheet materials 23 and has a material feeder 42, a forming machine 43 positioned downstream of the material feeder 42, a cutting machine 44 positioned downstream of the forming machine 43 and a discharger 45 positioned downstream of the cutting machine 44.

Description will now be made briefly of the forming procedures.

Firstly, a steel sheet 47 wound on the material feeder 42 is passed between forming rolls 51 and 52 in the forming machine 43 and a corrugated portion 24 is formed thereon when the forming rolls 51 and 52 are rotated.

Then, the steel sheet 47 having the corrugated portion 24 formed thereon is cut to a desired length by the cutting machine 44 to complete corrugated sheet materials 23.

Finally, the corrugated sheet materials 23 are lifted by the discharger 45 and stacked in a container 55. They are so stacked that the corrugated portion 24 of one material may not lie on that of another.

The position to start forming is, for example, controlled to ensure that the corrugated portion 24 of one material may not lie on that of another. The forming roll 51 is moved up and down as shown by arrows f1 to alter the length of the sheet which is moved forward without having any corrugated portion 24 formed thereon.

The corrugated sheet materials 23 shown in FIG. 4 are shown in a simple diagrammatic way and do not exactly represent the number of ridges or grooves defining the corrugated portion 24.

FIG. 5 shows a corrugated sheet material 23 used by a method of manufacturing a honeycomb metal support.

The corrugated sheet material 23 has a flat portion 64 formed on one side 63 of the middle portion 25 of a strip 61 and having one wound end 19 formed thereon, and corrugations 24 formed on the other side 65 thereof and terminating in a flat portion having a desired length Le and defining the other wound end 21.

According to this invention, however, the flat portion having a length Le is not essential, but the corrugated portion 24 may extend throughout the other side 65.

Wb (Wb=W (see FIG. 2)) denotes the width of the corrugated sheet material 23. The wound end 19 is the end of one side 63 of the corrugated sheet material 23. The wound end 21 is the end of the other side 65 of the corrugated sheet material 23.

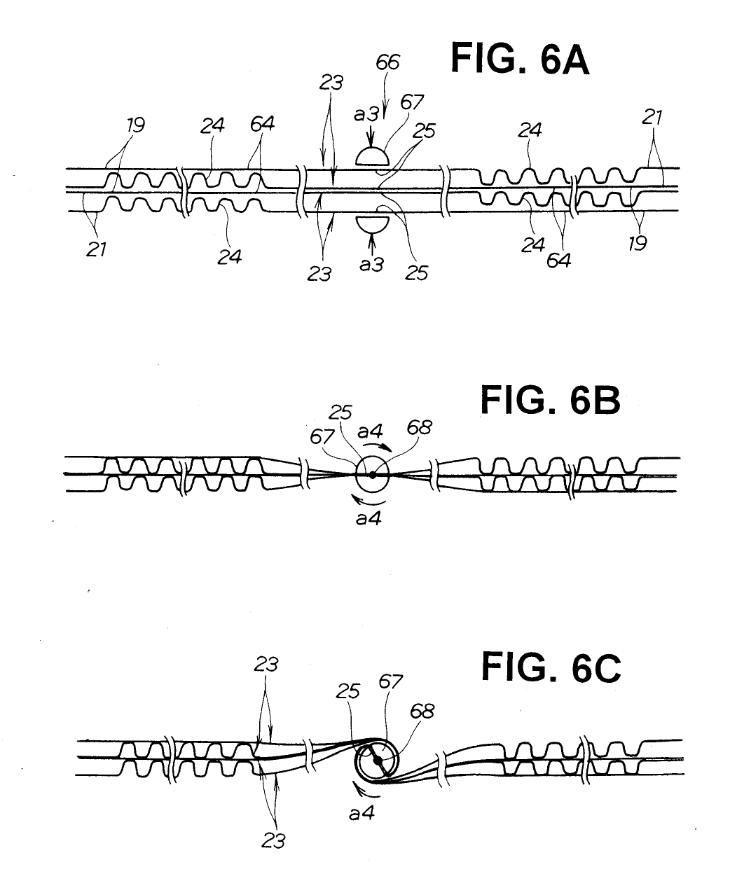

Then, four such corrugated sheet materials 23 are taken out and their winding is started as shown in FIGS. 6A to 6C.

Referring to FIG. 6A, four corrugated sheet materials 23 are taken out and set in the holding member 67 of a winding device 66. The corrugated sheet materials 23 are so superposed on one another that the flat portion 64 of one of them may lie on the corrugated portion 24 of another. Then, their middle portions 25 are pressed together by the holding member 67, as shown by arrows a3.

After their middle portions 25 have been pressed together, the holding member 67 is rotated about its central axis 68, as shown by arrows a4 in FIG. 6B.

The middle portions 25 are wound about the central axis 68 as shown by the arrow a4 in FIG. 6C to form a cylindrical portion 17 (see FIG. 1). Then, the winding of the corrugated sheet materials 23 is continued.

The continued winding of the corrugated sheet materials 23 forms a honeycomb portion 18 and the termination of their winding forms a honeycomb support 12, as shown in FIG. 7.

Finally, the honeycomb support 12 is fitted into a cylindrical member 13 as shown by an arrow a5, and the wound ends 19 and 21 of the honeycomb support 12 are fixed to the inner surface 22 of the cylindrical member 13.

More particularly, the cylindrical member 13 containing the honeycomb support 12 is turned down and while the cylindrical member 13 is rotated, welding is done along two portions shown by two-dot chain lines on the cylindrical member 13 (welds 14 and 15) to weld the cylindrical member 13 and the wound ends 19 and 21 of the honeycomb support 12 together along the two portions shown by the two-dot chain lines. As a result, a honeycomb metal support 11 as shown in FIG. 1A is completed.

As the method of manufacturing a honeycomb metal support 11 includes forming corrugated sheet materials 23 each having a flat portion 64 (having a wound end 19), a corrugated portion 24, a portion remaining flat along a length Le and a wound end 21, superposes the corrugated sheet materials 23 by making the flat portion 64 of one material lie on the corrugated portion 24 of another, winding the middle portions 25 of the corrugated sheet materials 23 to form a cylindrical portion 17, winding them further to form a honeycomb portion 18, terminating their winding to form a honeycomb support 12 and fixing the honeycomb support 12 to a cylindrical member 13, it makes it possible to fix the wound ends 19 and 21 of the honeycomb support 12 to the cylindrical member 13 easily and thereby raise the strength of the honeycomb support 12 against any temperature change or vibration without calling for any substantial time or labor.

A honeycomb metal support according to another embodiment of this invention will now be described with reference to FIGS. 8 to 13. As regards those portions of the honeycomb metal support 11A according to the other embodiment which are similar to those of the honeycomb metal support 11 according to the embodiment shown in FIGS. 1A to 7, the same symbols are assigned to them and no further description thereof is made.

The honeycomb metal support 11A according to the other embodiment as shown in FIG. 8 is characterized in that a cylindrical portion 17A has notches 72 extending from the opposite ends 71 thereof toward the widthwise middle portion 73 thereof. In other words, the opposite ends 71 of the middle portion 25 are not wound. Consequently, the cylindrical portion 17A has a smaller number of turns along the opposite ends 71 thereof than in the widthwise middle portion 73 thereof.

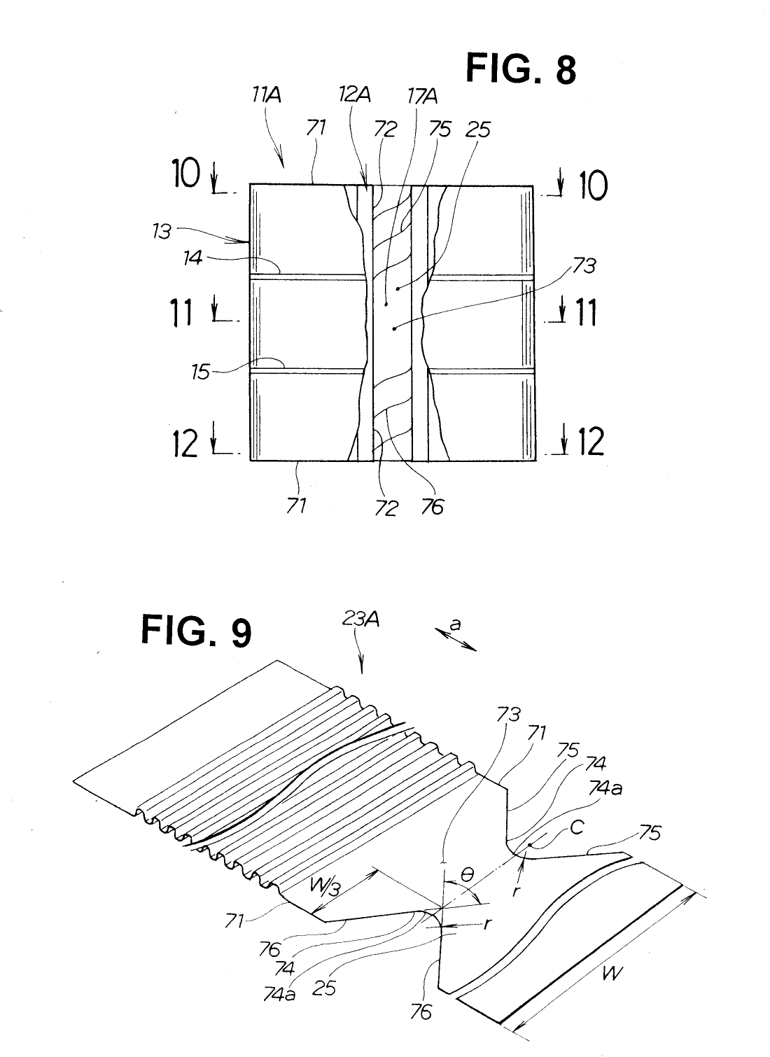

A corrugated sheet material 23A used to make the cylindrical portion 17A will now be described with reference to FIG. 9.

The corrugated sheet material 23A has V-shaped notches 74 extending from its longitudinally parallel ends 71 (in the directions of arrows a6) toward its widthwise middle portion 73, thereby allowing a smaller number of turns along the ends 71. C denotes the middle of its entire longitudinal length. The notches 74 are not limited to V-shaped ones, but may alternatively be U-shaped or arcuate.

Each notch 74 has a depth equal to W/3 and a cut angle θ. Each notch 74 is shown as having an arcuate portion 74a with a radius r close to the widthwise middle portion 73, though the arcuate portion 74a is not essential. Reference numerals 75 and 76 denote the edges defining the notches 74.

Each notch 74 is shown as having a depth equal to W/3 as stated, though its depth is not limited to W/3. It is also possible to set its depth as being equal to W/4 or W/5.

Although the corrugated sheet material 23A is shown as having equally shaped notches 74 toward the opposite ends of its middle portion 25, they may alternatively be different in shape. For example, one of the notches 74 may be U-shaped or only one of the notches 74 may have an arcuate portion 74a.

Although the notches 72 shown in FIG. 8 are equal to the notches 74 shown in FIG. 9, the different numerals are used, as the notches 72 shown in FIG. 8 are formed in the cylindrical portion 17B, while the notches 74 shown in FIG. 9 are formed in the corrugated sheet material 23A.

Although two notches 74 are shown as being formed on the opposite sides of the widthwise middle portion 73, it is alternatively possible to form only a single notch. For example, a notch 74 may be formed only at one end 71 of the corrugated sheet material 23A and a wound honeycomb support 12A formed by winding it may have a notch 72 (see FIG. 8) facing the inlet of exhaust gas, while its portion not having any notch faces its outlet.

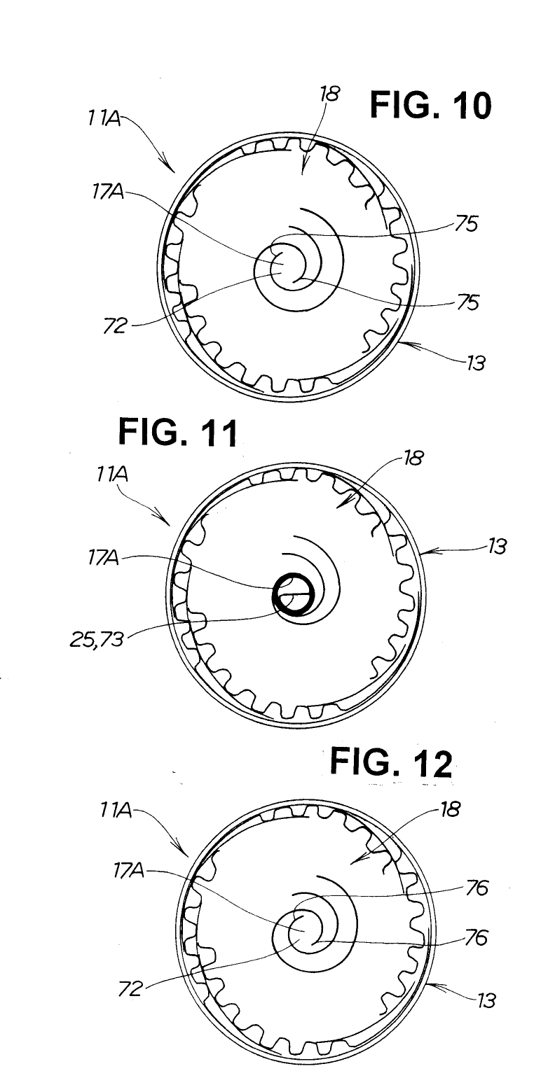

The cylindrical portion 17A of the honeycomb metal support 11A has a notch 72 as stated above and as shown in FIG. 10, the edges 75 defining the notch 72 stay apart from each other.

Referring to FIG. 11, the cylindrical portion 17A of the honeycomb metal support 11A is formed by winding the widthwise middle portion 73 of the corrugated sheet material 23A shown in FIG. 9.

The cylindrical portion 17A of the honeycomb metal support 11A has a notch 72 as stated above and as shown in FIG. 12, the edges 76 defining the notch 72 stay apart from each other.

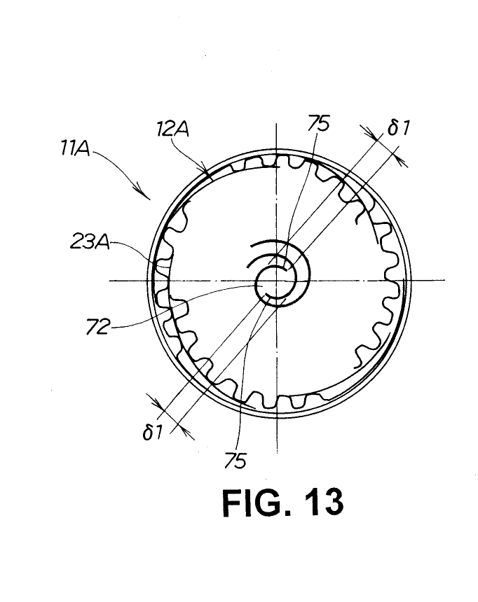

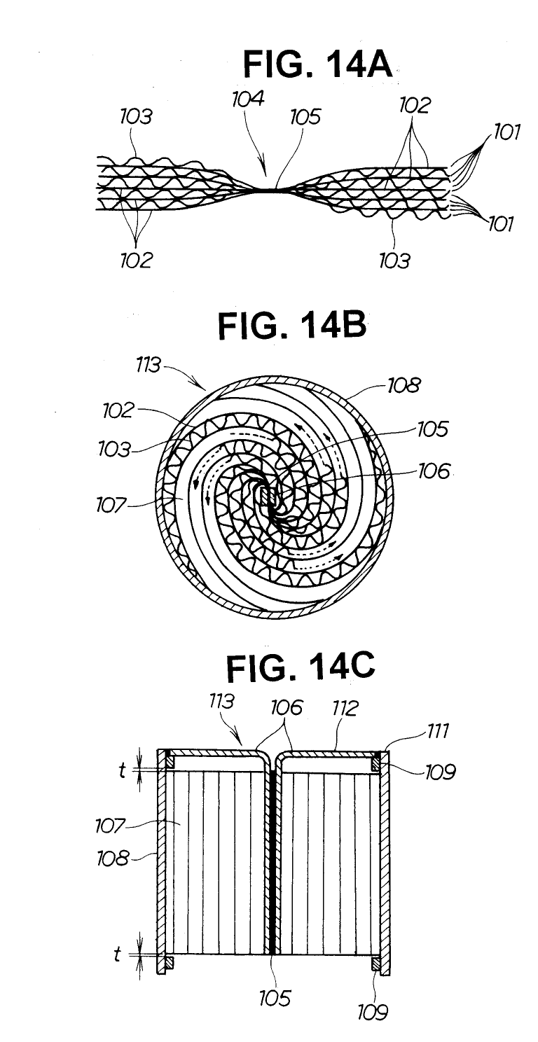

When the honeycomb support 12A in the honeycomb metal support 11A according to the other embodiment is heated by the exhaust gas of a motor vehicle or motorcycle and has its corrugated sheet materials 23A elongated by expanding, the edges 75 defining the notch 72 move by a distance 61 and thereby absorb their elongation, as shown in FIG. 13. Accordingly, it is still more certainly possible to prevent any deformation of the honeycomb portion 18 by thermal expansion.

Likewise, the edges 76 of the notch 72 shown in FIG. 12 move by approximately the same distance 61 and thereby absorb expansion. Accordingly, it is still more certainly possible to prevent any deformation of the honeycomb portion 18 by thermal expansion.

Although the effects have been explained of the notches 74 formed along the opposite edges of the corrugated sheet material 23A shown in FIG. 9, it is alternatively acceptable to form a notch 74 only along one edge thereof. In such a case, the honeycomb support 12A may have its notch 72 face the inlet of exhaust gas, while its portion not having any notch faces the outlet of exhaust gas, so that that part of the honeycomb portion 18 which faces the inlet of exhaust gas and has an elevated temperature may absorb any elongation of its middle portion by thermal expansion, and its rupture by thermal expansion may be prevented.

Although the honeycomb metal support and the method of its manufacture according to this invention have been described as a mode of application to a honeycomb structure for holding a catalyst, they are also applicable to any honeycomb structure used for purposes other than holding a catalyst.

### INDUSTRIAL APPLICABILITY

The honeycomb metal support and the method of its manufacture according to this invention are suitable for a honeycomb structure for holding a catalyst used to purify exhaust gas.

1. A honeycomb metal support characterized by comprising:
a honeycomb support having a cylindrical portion formed in its center by laminating a plurality of corrugated sheet materials each in the form of a corrugated strip and winding the laminated corrugated sheet materials about their middle portions; and
a cylindrical member allowing the honeycomb support to be fitted therein;
a honeycomb portion being formed contiguously to and outwardly from the cylindrical portion, each of the corrugated sheet materials having a wound end formed contiguously to and outwardly from the honeycomb portion and fixed integrally to the inner surface of the cylindrical member.

2. A honeycomb metal support as set forth in claim 1, wherein the cylindrical portion has a notch formed at least at one end thereof.

3. A method of manufacturing a honeycomb metal support which comprises the steps of:
forming a plurality of corrugated sheet materials each formed by adopting as a flat portion one portion of a strip on one side of its longitudinally middle portion and forming a corrugated portion on the other side of the middle portion;
laminating the corrugated sheet materials on one another so that the flat portion of one of them may lie on the corrugated portion of another;
winding the laminated corrugated sheet materials about their middle portions to form a cylindrical portion;
winding the corrugated sheet materials to a further extent to form a honeycomb support; and
fitting the honeycomb support in a cylindrical member and fixing the wound ends of the honeycomb support to the inner surface of the cylindrical member.
